(19) United States
(12) Patent Application Publication
(10) Pub. No.: US 2003/0052566 A1
(43) Pub. Date: Mar. 20, 2003

(54) Commutator for a multi-pole commutator motor and commutator motor provided therewith

(76) Inventors: Gerald Kuenzel, Buehl Vimbuch (DE); Joerg Brandes, Baden-Baden Neuweier (DE)

Correspondence Address: Striker Striker & Stenby, 103 East Neck Road, Huntington, NY, 11743, US

(21) Appl. No.: 10/220,589

(22) PCT Filed: Jan. 25, 2002
(86) PCT No.: PCT/DE02/00245

(30) Foreign Application Priority Data
Mar. 31, 2001 (DE) 101 16 182.4

(51) Int. Cl. H02K 1/00; H02K 13/04; H01R 39/04

(52) U.S. Cl. 310/236

(57) ABSTRACT

The invention concerns a commutator (22; 22a; 22b) for a multi-pole commutator motor (14) having at least four stator poles (16-19) and armature coils (31-42) interacting with them that are electrically interconnected with two commutator bars (1-12) each of the commutator (22; 22a; 22b) to supply current, and the number of which said armature coils is greater than the number of stator poles (16-19), whereby, in order to reduce the number of brushes (20, 21; 23, 24) contacted by the commutator (22; 22a; 22b), armature coils (31-42) forming armature poles having an identical magnetic polarity are connected in parallel by armature-end, electrical bridge conductors (43-48). With regard for the commutator (22; 22a; 22b), it is proposed that the bridge conductors (43-48) are a component of the commutator (22; 22a; 22b). The invention further concerns a multi-pole commutator motor (14) having a commutator (22; 22a; 22b) of this type.

### BACKGROUND OF THE INVENTION

The invention concerns a commutator for a multi-pole commutator motor having at least four stator poles and armature coils interacting with them, each of which said armature coils is supplied with current via two commutator bars of the commutator, and the number of which said armature coils is greater than the number of stator poles, whereby, to reduce the number of brushes contacting the commutator, armature coils forming armature poles having an identical magnetic polarity are connected in parallel by means of armature-end, electrical bridge conductors. The invention further provides a multi-pole commutator motor having a commutator of this type.

Commutator motors of this type are used, for example, as pump drives for antilock braking systems in motor vehicles, as servo units or as control drives. Commutator motors of this type can also be referred to as low-power motors, since they usually cover a power range up to approximately one kilowatt.

A typical example of a commutator motor of this type has four stator poles, for example, that preferably have permanent-magnet excitation, and, accordingly, four armature poles formed by armature coils and interacting with said stator poles. The armature coils are connected to an armature-end commutator that is supplied with current in the usual fashion via four brushes. The brushes ride on the commutator bars of the commutator.

To reduce the number of brushes, it is known in the related art to connect such armature coils in parallel by means of armature-end, electrical bridge conductors, which said armature coils form armature poles having an identical magnetic polarity. In the German patent document DE 197 57 279 C1, it is proposed for this purpose that the bridge conductors be designed as commutator bar contact bridges that are wound with winding wire as well when the armature coils are wound. The bridge conductors, as well as the armature coils, are hung in hooks located on the commutator bars in the direction facing the armature coils. Hanging the armature coils in the hooks is unproblematic, since the armature coils essentially extend in the direction of the axis of rotation of the armature and, thus, can be easily hung in the hooks. Hanging the bridge conductors in the hooks poses problems, on the other hand, since they must extend transversely to the direction of the axis of rotation of the armature, because diametrically opposed commutator bars are typically interconnected by the bridge conductors. Additionally, it is necessary to provide an electrically insulating section on the shaft of the armature to support the bridge conductor.

In the case of commutator motors having greater power—substantially greater than one kilowatt, in any case—commutator bars are connected in parallel by means of equipotential connections to allow compensatory currents to flow between the commutator bars, so that the brushes are not loaded with compensatory currents. A reduction in the number of brushes is not provided, either, and, in powerful motors of this type, this would result in high commutator currents, which would result in problematic current-chopping behavior, and possibly even a flashover on the commutator.

### ADVANTAGES OF THE INVENTION

In contrast, the commutator according to the invention having the features of the main claims and the multi-pole commutator equipped therewith have the advantage that the act of winding the armature is substantially simpler, since bridge conductors made of winding wire are not provided. Instead, the bridge conductors are a component of the commutator itself.

Advantageous further developments and improvements of the commutator according to the invention and of the commutator according to the invention are possible due to the measures listed in the dependent claims.

The bridge conductors are preferably located directly between commutator bars of the commutator, so that the commutator is very compact in shape.

Various design variants of the commutator are possible. For example, it can be a plane or flat commutator, now also referred to as a disk commutator, or a “drum” commutator. In any case, the commutator preferably has a circular or drum-like shape, whereby the commutator bars are located on the outer periphery of the commutator and the bridge conductors are located in the interior of the commutator to save space.

Typically, an armature shaft extends through a commutator. It is therefore preferably provided that a passage for the armature shaft is kept free in the interior of the commutator, advantageously along its axis of rotation. The bridge conductors are thereby bent, so to speak, around the armature shaft.

It is advantageously provided that diametrically opposed commutator bars on the periphery of the commutator are connected in parallel by one bridge conductor in each case. This variant is particularly advantageous in the case of a four-pole commutator motor. It is understood, however, that not just two armature coils, but also more armature coils, if necessary, can be connected in parallel by bridge conductors. For example, in the case of a six-pole commutator motor, three armature coils each can be connected in parallel, so that only one pair of brushes is needed for contacting the collector.

In a preferred variant, the bridge conductors are arranged essentially in a common plane. It is also possible that a group of bridge conductors or multiple groups of bridge conductors is/are each arranged essentially in common planes.

In any case, a very space-saving arrangement of bridge conductors results, so that the commutator is very compact in shape in the direction of the axis of rotation. This variant proves advantageous in the case of a disk commutator in particular. To contact the commutator bars associated with them, the bridge conductors reach over or under—at one end in each case—the common plane in which the respective bridge conductors are located.

It is also possible, however, that the bridge conductors are arranged in tandem. They are thereby located in planes situated in tandem in the direction of the axis of rotation of the commutator. It is therefore possible that all bridge conductors have the same geometric form. This variant is practical in the case of a drum commutator in particular.

The bridge conductors are advantageously formed by metallic conductors, made of copper or aluminum, in particular, that are soldered or welded between the commutator bars, or that are electrically contacted with them in any other fashion. It is understood, however, that the commutator bars and the bridge conductors associated with them can also be designed as single components. In any case, the mechanical loadability and stability of the commutator is improved by means of the bridge conductors located between the commutator bars.

Advantageously, the bridge conductors are fixed in position mechanically by means of an insulating mass, in particular a sealing compound, that is poured into the interior of the commutator, so that the stability of the commutator is further improved.

No restrictions must be placed on the type of winding of the armature coils as a result of the bridge conductors being integrated in the commutator. In a preferred variant of the invention, it is provided, however, that the armature coils are wound as multi-pole loop windings. In any case, it proves advantageous in all types of winding that the number of brushes provided for contacting the armature coils is less than the number of armature poles. Although this increases the current load on the individual brushes, it plays a negligible role in the case of small-power motors having an output of up to approximately one kilowatt, for which the commutator according to the invention is provided, since the brushes used there are typically dimensioned so that they can withstand a greater current resulting from the reduction in the number of brushes. In any case, the cost advantage realized by reducing the number of brushes is so great that the costs for providing higher-output brushes are compensated for.

### DRAWINGS

Exemplary embodiments of the invention are presented in the drawings and explained in greater detail in the subsequent description.

FIG. 1 shows a winding scheme of a rotor of a four-pole commutator motor having twelve grooves and twelve commutator bars, and having bridge conductors sketched in the drawing schematically,

FIG. 2 shows a commutator according to the invention in which the bridge conductors are located in planes arranged in tandem in the direction of the axis of rotation of the commutator, and

FIG. 3 shows a further variant of a commutator according to the invention in which the bridge conductors are essentially situated in a common plane.

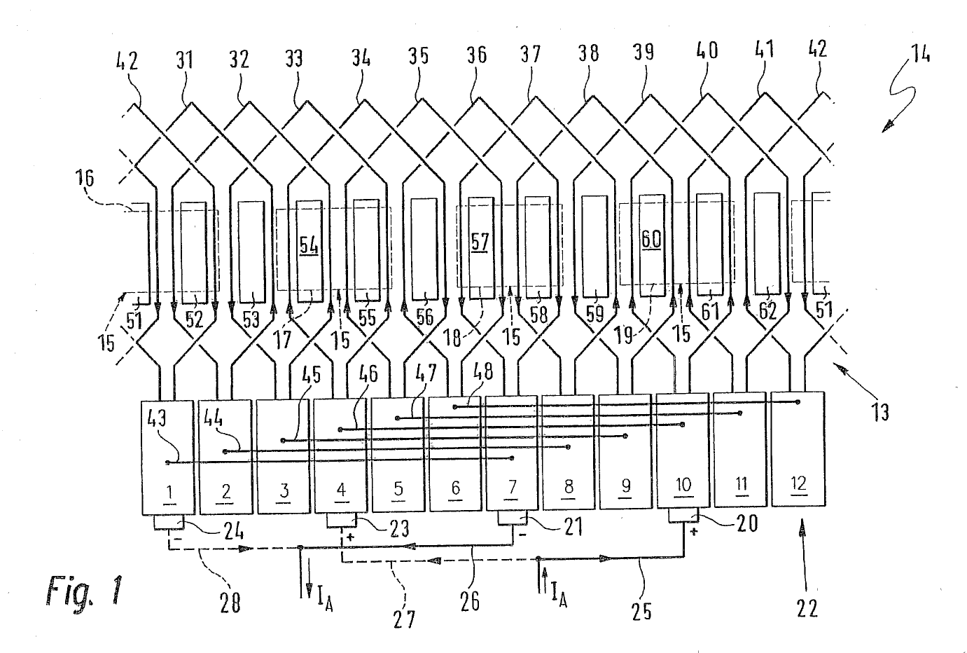

FIG. 1 shows the winding scheme of an armature 13 of a four-pole commutator motor 14. The commutator motor 14 has a stator 15 with stator poles 16, 17, 18, 19. Stator poles 16 through 19 can have electrical or permanent-magnetic excitation.

The armature 13 is situated in the stator 15 in such a fashion that it is allowed to rotate freely. Coils 31 through 42 are supplied with current via brushes 20 and 21 that ride on the commutator 22. The commutator 22 has commutator bars 1 through 12 that are electrically interconnected with coils 31 through 42. One end of coil 31 is interconnected with commutator bar 1 and the other end is interconnected with commutator bar 2. One end of coil 32 is interconnected with commutator bar 2 and the other end is interconnected with commutator bar 3. The further coils 33 through 42 are also interconnected with commutator bars 3 through 12,1 according to this scheme.

Coils 31 through 42 are arranged on the armature 13 in loop windings. With this type of winding, the same number of brush sets is required per se as there are excitation pole pairs belonging to the respective commutator. In the actual case, for example, this means two brush sets having two brushes each. The loop winding can also be referred to as a parallel winding, since the winding parts of the armature are connected in parallel by the brushes of brush sets that are connected in parallel in the case of conventional commutator motors. This is indicated in FIG. 1 by brushes 23, 24, which are connected in parallel with brushes 20, 21. The brushes 23, 24 are not actually provided in the case of the commutator motor 14. Supply conductors 25 and 26 lead to the brushes 20, 23 and 21, 24. A section 27 of the supply conductor 25 leading to brush 23 as well as a section 28 of the supply conductor 26 leading to brush 24 are shown only as dashed lines, because they are not provided in the case of the commutator motor 14 shown, although they are provided in a conventional commutator motor.

Each of the coils 31 through 42 is composed of a plurality of windings of a metallic conductor, e.g., an insulated copper wire, each of which said windings is wound numerous times around armature teeth 51 through 62, and each of the ends of which said windings is interconnected electrically with commutator bars 1 through 12. Coil 31, for example, is wound numerous times around armature teeth 51, 52 and 53, so that its windings come to rest between the armature teeth 51, 56 and 53, 54. Furthermore, coil 31 is electrically interconnected with commutator bars 1 and 2. The further coils 32 through 42 are wound around armature teeth 51 through 62 according to the same loop winding scheme.

To facilitate a better understanding, the current flow through the armature 13 that would occur with a conventional commutator motor in which the brushes 23, 24 are provided will now be explained. Half of an armature current I_{A} flows via the supply conductor 25 to each of the commutator bars 4, 10. From the commutator bar 10, the armature current I_{A}/2 flows via the coil 40 to the commutator bar 11, from there further via the coil 41 to the commutator bar 12 and, from there further via the coil 42 to the commutator bar 1. From there, the armature current I_{A}/2 can return to ground, in the case of a conventional commutator motor, via the brush 24 and the leads 28, 26. The brush 24 is not present in the case of the commutator motor 14, however. Instead of the brushes 23, 24, commutator 22 has bridge leads 43 through 48 that extend between commutator bars 1, 7; 2, 8; 3, 9; 4,10; 5,11; 6,12. Bridge leads 43 through 48 are a component of the commutator 22 and establish an electrical connection between commutator bars 1, 7; 2, 8; 3, 9; 4, 10; 5, 11; 6, 12 in each case. In contrast to the situation with the conventional commutator motor, half of the armature current I_{A}/2 arriving at the commutator bar 1 can return to ground via the bridge conductor 43 to commutator bar 7 and, from there, via the brush 21 and the conductor 26.

In the case of a conventional commutator motor, the other half of the armature current I_{A}/2 would flow via the brush 23 to the commutator bar 4. In the case of the commutator motor 14 in the armature position shown, the bridge conductor 45—instead of the brush 24—conducts half of the armature current I_{A} to the commutator bar 4, from where it is directed to the coil 34. The armature current I_{A}/2 flows via coil 34 to commutator bar 5, from there via coil 35 further to commutator bar 6, and via coil 36 to commutator bar 7, where it can return to ground via the brush 21 and the lead 26.

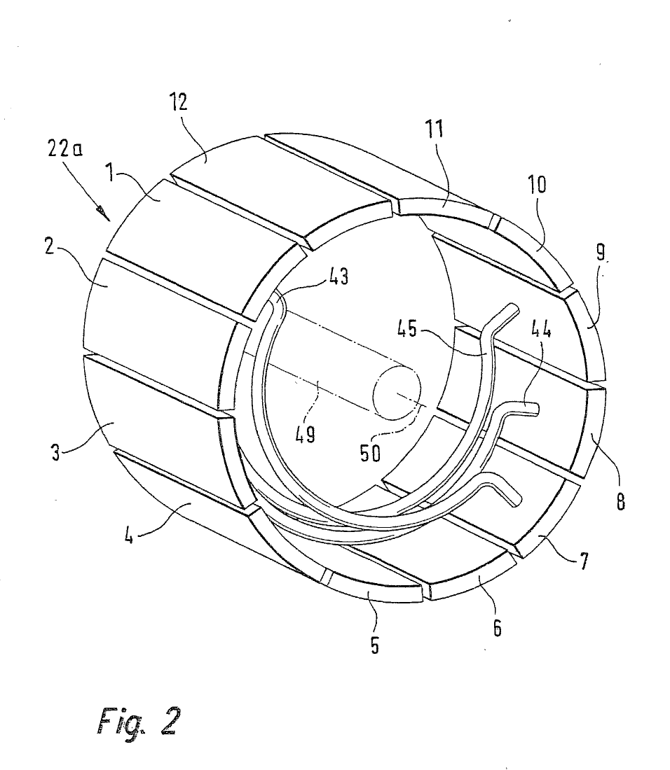

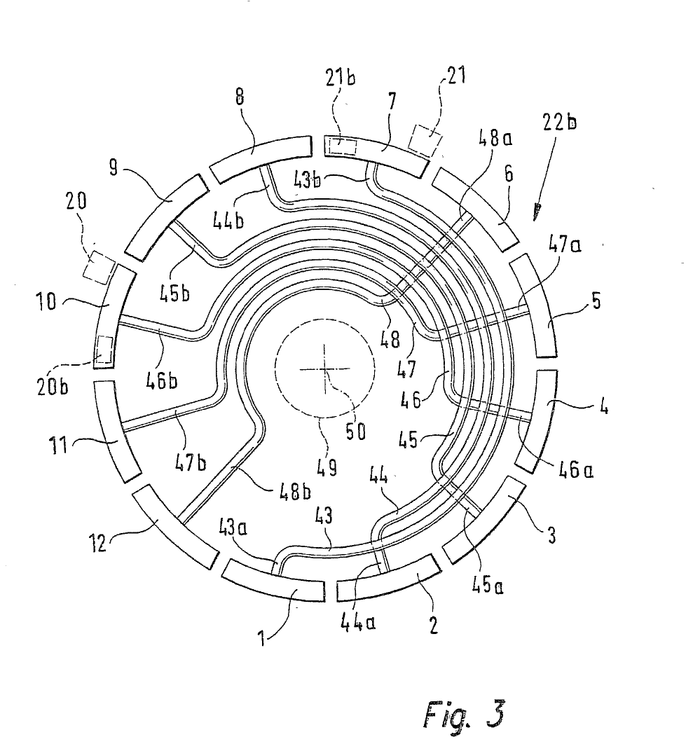

Exemplary configurations of the bridge conductors 43 through 48 integrated in the commutator 22 are shown in FIGS. 2 and 3. FIG. 2 shows the commutator 22 in a configuration 22a as drum commutator or drum collector. It has a roller or drum-like shape, and is penetrated by an armature shaft 49 of the armature 13 drawn with a dash-dotted line in the illustration. The commutator bars 1 through 12 are arranged on the periphery. A drum commutator is typically produced out of a copper tube, the interior of which is already filled with a not shown electrically insulating sealing compound, and the outer periphery of which is slit, so that commutator bars that are electrically separated from each other are formed. The sealing compound is not shown in FIG. 2 in order to facilitate clarity and to reveal the bridge conductors 43, 44, 46—drawn in the illustration as examples—that are developed as metallic conductors that are soldered or welded in place between commutator bars 1, 7; 2, 8; 3, 9. The further bridge conductors 46 through 48 can be constructed and arranged the same as bridge conductors 43 through 45. They are not shown, however, to ensure transparency.

In the case of the commutator 22a, the bridge conductors 43 through 48 are essentially bent in the shape of an arc, whereby the radius of the arc is dimensioned so that the bridge conductors keep a passage clear for the armature shaft 49 on the one hand and, on the other, are separated from the commutator bars 1 through 12 at such a distance in each case that electrical insulation is obtained. The bridge conductors 43 through 48 are bent outwardly in each case toward the periphery of the commutator 22a and they are welded or soldered with one commutator bar 1 through 12 in each case. The bridge conductors 43 through 48 are arranged in tandem along an axis of rotation 50 of the commutator 22a, which simultaneously forms the axis of rotation of the armature shaft 49. In any case, bridge conductors 43 through 48 connect diametrically opposed commutator bars 1 through 12 on the periphery of the commutator 22a, so that they are connected in parallel.

Additionally, the stability and mechanical loadability of the commutator 22a is increased by means of the mechanical connection of commutator bars 1 through 12 by one bridge conductor 43 through 48 each. A further increase of the mechanical loadability is obtained by pouring a sealing compound into the interior of the commutator 22a. If an insulating sealing compound is advantageously used, electrical insulation can also be obtained between bridge conductors 43—48 and/or commutator bars 1-12. A passage for the armature shaft 49 can be kept clear during pouring, or the armature shaft 49 can be cast directly in the process.

In the case of variant 22b of the commutator 22 shown in FIG. 3, bridge conductors 43 through 48 essentially lie in a plane. The commutator 22b can also be a “drum commutator”, whereby the brushes 21, 22—as shown as dashed lines in FIG. 3—ride on commutator bars 1 through 12 on the periphery of the commutator 22b. It is also feasible that the commutator 22b is designed as a plane or flat commutator, in which brushes 20b, 21b contact the commutator bars 1 through 12 on the end face of the commutator 22b. The brushes 20b, 21b are also drawn as a variant in the illustration using dashed lines.

In the case of the commutator 22b as well, bridge conductors 43 through 48 are arranged and shaped in such a fashion that a passage for the armature shaft 49 is kept free in the interior of the commutator 22b. Bridge conductors 43 through 48 are bent around an axis of rotation 50 of the commutator 22b in a concentric arc and essentially lie in a common plane. On their ends, bridge conductors 43 through 48 have sections 43a, 43b through 48a, 48b extending transversely to the axis of rotation 50 and pointing toward the outer periphery of the commutator 22b in each case, which said sections are electrically connected with commutator bars 1, 7; 2, 8; 3, 9; 4, 10; 5, 11; 6, 12. Sections 44a through 48a of bridge conductors 44 through 48 extend beneath the common plane in which the bridge conductors 43 through 48 are situated.

In the case of commutator 22b, bridge conductors 43 through 48 are formed by conductor tracks, for example, that are arranged on an electric printed-circuit board. A conductor track plane of the electrical printed-circuit board then forms the common plane for bridge conductors 43 through 48, whereby through-hole platings can be provided, for example, to extend over or under the plane of the conductor track. If the commutator 22b is a flat commutator, commutator bars 1 through 12 can also be formed by conductor tracks on the printed-circuit board.

It is understood that further embodiments of the invention are immediately possible. With regard for the embodiment of the bridge conductors in particular, which are a component of the commutator, further configurations are immediately feasible.

Moreover, random combinations of the measures indicated in the description and in the claims are also possible. In particular, the variants shown in FIGS. 2 and 3 can be immediately combined with each other.

What is claimed is:

1. A commutator for a multi-pole commutator motor (14) having at least four stator poles (16-19) and armature coils (31-42) interacting with them that are electrically interconnected with two commutator bars (1-12) each of the commutator (22; 22a; 22b) to supply current, and the number of which said armature coils is greater than the number of stator poles (16-19), whereby, in order to reduce the number of brushes (20, 21; 23, 24) contacting the commutator (22; 22a; 22b), armature coils (31-42) forming armature poles having an identical magnetic polarity are connected in parallel by means of armature-end, electrical bridge conductors (43-48), wherein the bridge conductors (43-48) are a component of the commutator (22; 22a; 22b).

2. The commutator according to claim 1,
wherein the bridge conductors (43-48) are located directly between commutator bars (1-12) of the commutator (22; 22a; 22b).

3. The commutator according to claim 1 or 2,
wherein the commutator (22; 22a; 22b) has a circular or drum-like shape, in particular is designed as a disk or drum commutator,
the commutator bars (1-12) are located on the outer periphery of the commutator (22; 22a; 22b), and
the bridge conductors (43-48) are located in the interior of the commutator (22; 22a; 22b).

4. The commutator according to one of the preceding claims,
wherein the bridge conductors (43-48) are designed and arranged in such a fashion that a passage for an armature shaft (49) is kept clear in the interior of the commutator (22; 22a; 22b), preferably along its axis of rotation.

5. The commutator according to one of the preceding claims,
wherein diametrically opposed commutator bars (1-12) on the periphery of the commutator (22; 22a; 22b) are connected in parallel by one bridge conductor (43-48) each.

6. The commutator according to one of the preceding claims,
wherein the bridge conductors (43-48) or a group of bridge conductors (43-48) are/is essentially located in a common plane.

7. The commutator according to claim 6,
wherein the bridge conductors (43-48) and/or the bridge conductors (43-48) of the bridge conductor groups extend over or under the common plane on one end at least partially in each case to contact the commutator bar (1-12) associated with them.

8. The commutator according to one of the claims 1 through 7,
wherein the bridge conductors (43-48) are located in planes arranged in tandem in the direction of the axis of rotation of the commutator (22; 22a; 22b).

9. The commutator according to one of the preceding claims,
wherein the bridge conductors (43-48) are formed by metallic conductors, preferably made of copper or aluminum, soldered or welded between the commutator bars (1-12).

10. The commutator according to one of the preceding claims,
wherein the bridge conductors (43-48) are fixed in position mechanically by means of an insulating mass, in particular a sealing compound.

11. The commutator according to one of the preceding claims,
wherein it is provided for a multi-pole commutator motor (14) serving as an electric small-power motor, in particular as a pump drive of an antilock braking system for motor vehicles, as a servo unit or as a control drive, in particular in a power range up to one kilowatt.

12. A multi-pole commutator (14) having a commutator (22; 22a; 22b) according to one of the preceding claims.

13. The multi-pole commutator (14) according to claim 12,
wherein the armature coils (31-42) are wound as multi-pole loop windings.

14. The multi-pole commutator (14) according to one of the preceding claims 12 or 13,
wherein the number of brushes (20, 21; 23, 24) provided for contacting the armature coils (31-42) is smaller than the number of armature poles.

15. The multi-pole commutator (14) according to one of the claims 12 through 14,
wherein it is designed as an electric small-power motor, in particular as a pump drive of an antilock braking system for motor vehicles, as a servo unit or as a control drive, in particular in a power range up to one kilowatt.
